(19) United States
(12) Patent Application Publication
(10) Pub. No.: US 2004/0130425 A1
(43) Pub. Date: Jul. 8, 2004

(54) Enhanced RF wireless adaptive power provisioning system for small devices

(76) Inventors: Tal Dayan, Los Gatos, CA (US); Dan Kikinis, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/640,211

(22) Filed: Aug. 12, 2003

Related U.S. Application Data
(60) Provisional application No. 60/403,223, filed on Aug. 12, 2002.
(60) Provisional application No. 60/403,069, filed on Aug. 12, 2002.

(51) Int. Cl. H01F 5/00

(52) U.S. Cl. 336/200

(57) ABSTRACT

An apparatus to provide wireless powering of a mobile device comprising a pad having an embedded coil, the coil driven by a power oscillator and is controlled by a controller, to provide a narrow-band resonance coupling.

This application claim priority to, and incorporates by reference its U.S. provisional application No. 60/403,223 filed Aug. 12, 2002 titled “Enhanced RF Wireless Adaptive Power Provisioning System For Small Devices” (Attorney Docket No. 6041.P006z), and related U.S. provisional application No. 60/403,069 filed Aug. 12, 2002 titled “Enhanced RF Wireless Adaptive Power Provisioning System” (Attorney Docket No. 6041.P007z). This application incorporates by reference co-pending patent application titled “Alternative Wirefree Mobile Device Power Supply Method and System With Free Positioning” filed Aug. 1, 2002, application Ser. No. 10/211,224, Attorney Docket No. 6041.P005.

### BACKGROUND

One other approach for wireless powering of small mobile devices is using inductive coupling. Although mentioned in the co-pending application, it is a tricky approach. Leakage is the biggest problem, but load matching, inducing eddy currents in untargeted objects and hence heating them, or shorting the supply are just a few to mention.

What is clearly needed is a method and system to improve the yield by doing a finely tuned microprocessor-controlled, narrow-band resonance coupling, hence improving the coupling to almost no loss in the near field, and at the same time keeping the far field virtually zero.

### BRIEF DESCRIPTION OF THE DRAWINGS

FIG. 1 illustrates a pad in which a coil is embedded in accordance with one embodiment.

FIG. 2 illustrates a notebook in which a coil is attached to the bottom in accordance with one embodiment.

FIG. 3 illustrates a schematic overview of electrical circuitry of a system in accordance with one embodiment.

FIG. 4 illustrates an additional schematic overview of electrical circuitry of a system in accordance with one embodiment.

FIG. 5 illustrates an implementation of one embodiment.

FIG. 6 illustrates an overview diagram of the network connectivity in accordance with one embodiment.

FIG. 7 illustrates flow diagram of the process in accordance with one embodiment.

### DESCRIPTION OF THE EMBODIMENT

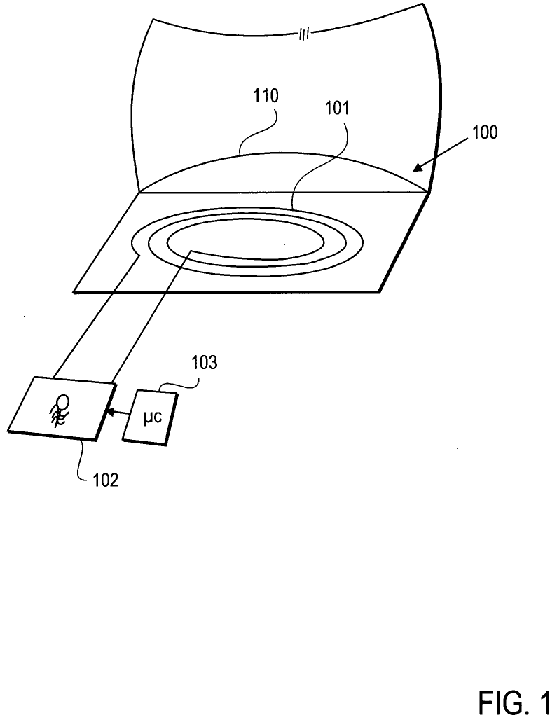

FIG. 1 shows a pad 100 in which a coil 101 is embedded. The coil is driven by a power oscillator 102 (power source not shown) and is controlled by intelligent controller 103, which may contain a microcontroller. Also shown is the near field 110 and the far field 111, which are available. The near field is defined typically as the field within the geometry size of the coil itself (i.e., if the coil is 5 inches in diameter, the near field would be that order of magnitude, whereas a point 50 inches away would be considered in the far field), while the far field is typically defined as the field seen from a distance of a multiple of the geometry of the device. Typically measurements for EMI are done at a distance of approximately 5 meters or more from the device, and actually they are mostly measuring the far field, whereas near field sniffer ports are used only for determining potential leaks, etc.

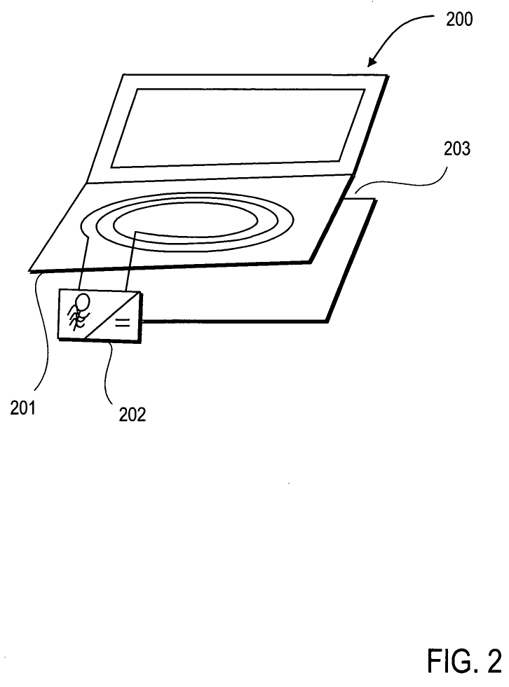

FIG. 2 shows a notebook computer 200 with a coil 201 attached to its bottom. Also attached is an RF-to-dc converter 202 and a dc plug 203 that is connected to converter 202 and plugged into a normal dc power supply pin of the notebook. It is clear that in some cases, the receiving system consisting of coil, RF/dc converter, etc., may be integrated into the host and not require an external supply connector. In some cases the RF-to-dc converter is an intelligent-type regulator, in other cases, it may be simply a basic diode/capacitor rectifying system or any type in between. As described earlier in co-pending patent application Ser. No. 10/211,224, Attorney Docket No. 6041.P005, an array of coils can be used to improve coupling by always allowing a “reasonable” set of inductors/antennae to be found between the base and the device. A normal type of MOSFET can be used to switch, using a small dc bias to enable switching and sending the RF energy on top.

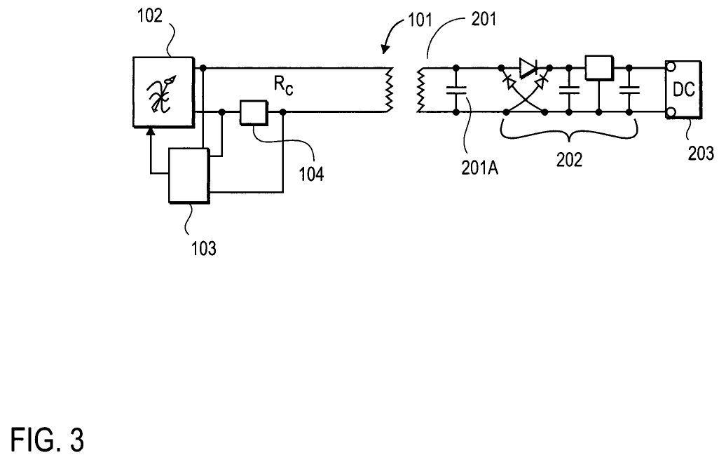

FIG. 3 shows a schematic overview of the electrical circuitry of the system. Power generator 102 drives the inductor coil 101 in the pad. In some cases, the inductor may not be an actual coil, but rather an antenna with microwave strips, etc., depending on the frequency selected. In yet other cases, it may be integrated into a PCB, etc. Typically, such a device would operate in either the 900 megahertz or in the 2.4 gigahertz range, but almost always in an industrial, scientific and medical (ISM) band, so slight leakage in the far field would be deemed acceptable. In one case, a 13.5 MHz ISM band is used, with a plurality of coils embedded in the base unit. That frequency (also an ISM band) lends itself nicely, since it is high enough to not require expensive ferrite cores, but is low enough to provide high power with little skin effect. Trying to reduce skin effect could dramatically increase the cost of the coils. The switches used in a matrix, as described above, should have a transit frequency of at least 5× the primary carrier (i.e., Ft=100 MHz>5*13.5=67.5 MHz), which are still economically feasible.

Regulator 103 shows more detail. In particular, it measures the power sent into the coil 101 by the means of sensing across the voltage wires and measuring at sense resistor 104 to determine how much power is actually drawn. The results would then be used by regulator 103 (i.e., a microprocessor, not shown) to drive the controls of the oscillator 102. These controls may include one or more of the frequency, frequency spread (that is, the bandwidth), and total power pushed into the inductor (or transmitting antenna) 101.

The recipient antenna or inductor 201 forms, with capacitor 201a (previously not shown), a resonance receiving antenna system that is narrowly tuned. The higher the Q (quality quotient of the resonance circuit), the narrower the band it draws power on, and the better the coupling between the two, even if the mechanical situation is not ideal. Converter 202 is the ac or RF-to-dc converter, shown here with a bridge rectifier capacitor, an electronic regulator block, and another filter capacitor before going to dc connector 203.

The quality of this circuitry may depend a lot on the Q, but also on the capability to control multiple loads. In some cases, a regulator may be contained in the host device, such that communication received in the host side regulator could include, for example, FM-modulated, AM-modulated, or other data that runs on the same carrier (frequency) that is carrying power, and such data can be introduced by controller 103 by modulating the center frequency of oscillator 102, or other appropriate means to achieve the desired type of modulation (not shown).

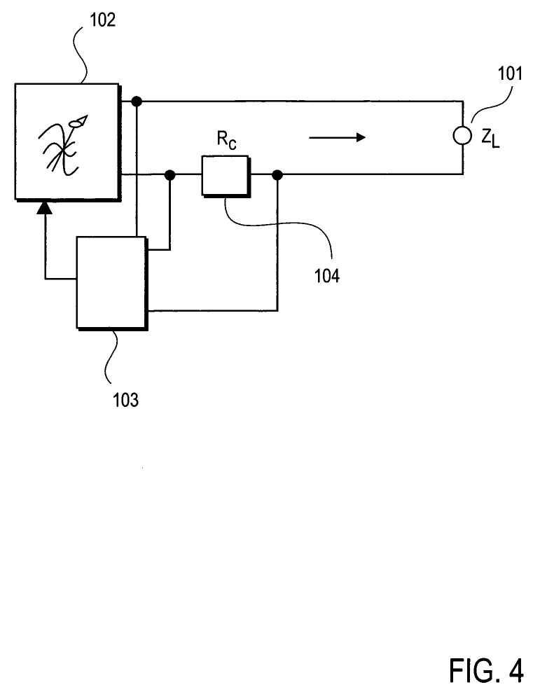

FIG. 4 shows a further simplified circuitry with the oscillator 102, the intelligent controller 103, the sensing resistor 104, and a load resistor 401 that represents the equivalent power load that is “seen” from the oscillator, in the case of an ideal resonant coupling of both coils and or antennae. The reactive component of ZL, which can be determined by regulator/controller 103′ using its sense lines over Sense Resistor 104 (RS) lets regulator 103′ determine coupling and transmission (transformation) ratio, of the actual situation, allowing a crude first regulation that compensates for the transformation ratio between inductors. Further, the communication link allows fine tuning by communicating between both sides. The back pass of the communication may be done by modulating the load signal, resulting in a specific pattern at the gross regulator on the primary side.

It is clear that by managing the power regulation on the receiving side, the semblance of Z_{L} may be tweaked. It is also clear that by controlling multiple devices and communicating among said devices, an overload of the circuitry, for example, may be avoided, in case too many devices try to share one pad. A signal could be sent that allows only certain devices to participate, with others being told to delay charging. In yet other cases, the frequency of resonance of different devices may be slightly skewed, thus allowing multiplexing of power distribution by not tightly coupling all devices at the same time. Such an approach would be suitable for the times when greater amounts of power are needed in one or another device, because only certain devices would receive energy at a given time, depending on their resonances. Multiplexing could be done by frequency hopping on the oscillator side, or by other means, such as communicating and telling power regulators to back off.

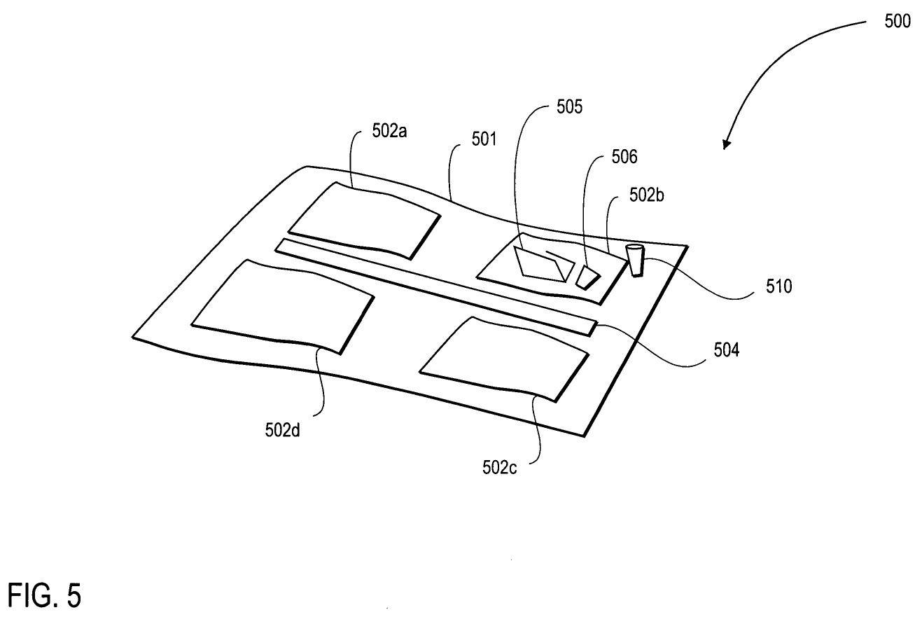

FIG. 5 shows a table 501 in a coffee shop 500 that has, for example, four sections 502 a-d. On one of the sections (section 502b) the user has installed himself by setting down his notebook 505, his cell phone 506, and half a cup of cappuccino 510.

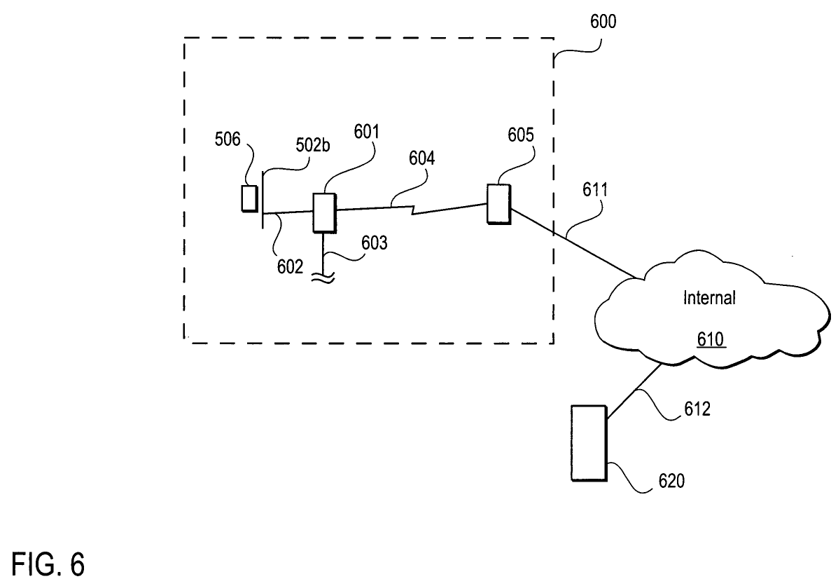

FIG. 6 is an overview diagram of the network connectivity required. In this example, only cell phone 506 is shown, sitting on table section 502b; however, it is clear that more than one device may be connected at one time. Table section 502b is connected to intelligent controller 601, which has access to a power source 603 and also access to network 604, typically going through a router/firewall device 605 and Internet connection 611 to the Internet 610; from where a connection 612 leads to a server 620 that maintains the user's account.

According to the user's preferences an account has been set up on the server that describes the features of the account, such as power, networking, etc., and the means of payment, for example, by time and/or actual power usage and/or megabytes of data uploaded or downloaded. All this data for each account is on file in a database (not shown) on the server.

The account services may be charged as a flat monthly fee, and a record of the megabytes used kept only for internal usage, or the account may be billed by megabytes transferred. The fee structures may be in place for power usage: it may be billed as a flat fee for usage, or the fees may be on an hourly basis, where, for example, the user gets X hours of charging time, regardless of whether he uses the power for one or for multiple devices.

To invoke the account services, the user may go to a Web site where he can register his devices to his account. Hence when the device ID comes up, the server knows which account permissions to retrieve.

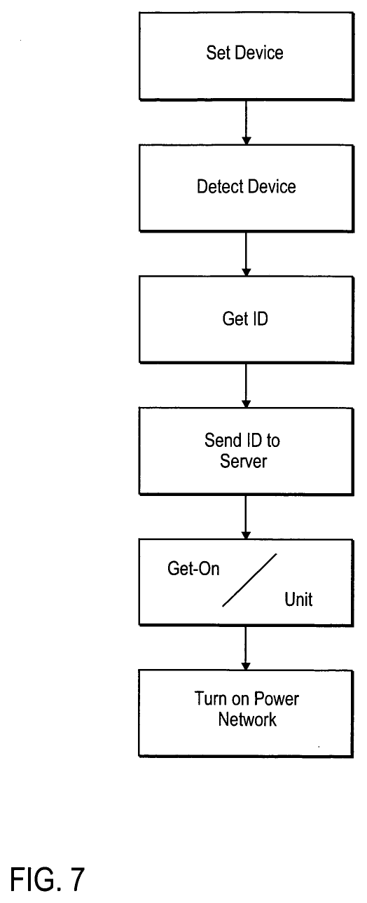

FIG. 7 shows a simplified flow diagram of the process of the novel art of this disclosure. In step 701, a device is set on the table section. In step 702, the presence of the device is detected. In step 703 the ID is obtained from the device, as described above. In step 704, that ID is sent to the server and is looked up to identify the user account. Then in step 705, according to the account permissions, a record that OKs the usage and gives limits, rates, etc., is sent back and received. In step 706, the power and/or network restrictions for an unauthorized user are lifted, and the user is free to use power and networking services provided by his account for his device.

The structure of the database is not described here in detail, but no special technique is required. It is well known in the art how to design databases that can look up, for example, an ID that is associated with an account and can obtain account-related information.

It is clear that many modifications and variations of this embodiment may be made by one skilled in the art without departing from the spirit of the novelty of the art of this disclosure.

1. An apparatus to provide wireless powering of a mobile device comprising:
A pad having an embedded coil, the coil driven by a power oscillator and is controlled by a controller, to provide a narrow-band resonance coupling.
